(19) United States
(12) Patent Application Publication
(10) Pub. No.: US 2006/0096627 A1
(43) Pub. Date: May 11, 2006

(54) System and method for powder coating crutches

(76) Inventor: Laurie L. Johnson, Edwards, CO (US)

Correspondence Address: DORSEY & WHITNEY LLP;INTELLECTUAL PROPERTY DEPARTMENT, 50 SOUTH SIXTH STREET, MINNEAPOLIS, MN, 55402-1498, US

(21) Appl. No.: 11/067,509

(22) Filed: Feb. 25, 2005

Related U.S. Application Data
(63) Continuation-in-part of application No. 10/982,413, filed on Nov. 5, 2004.

(51) Int. Cl. A61H 3/02

(52) U.S. Cl. 135/68

(57) ABSTRACT

The present invention provides for a powder coated crutch frame and underarm covers and hand grip covers for the same. The powder coating process may be applied to the entire crutch frame, or a subset of the frame components, and provides a more robust crutch frame by affording additional durability and protection. The covers can be constructed from different types of fabrics with various types of designs. The underarm cover defines a curved shape that generally conforms to the curved contour of the underarm pads. The hand grip covers are formed from a single piece of fabric sewn into a tubular shape to receive the hand grips of the crutch.

### CROSS-REFERENCE TO RELATED APPLICATIONS

This application is a continuation-in-part application of application Ser. No. 10/982,413, filed Nov. 5, 2004, and entitled, “Covers for Crutches,” which is hereby incorporated herein by reference.

### BACKGROUND OF THE INVENTION

a. Field of the Invention

This invention relates to crutches with powder coated frames and to underarm covers and hand grip covers for the same.

b. Background Art

A variety of covers for underarm pads and hand grip pads on crutches exist having various designs and configurations. Some underarm crutch covers adapted to cover the underarm pads on crutches are configured with an elastic band that draws a perimeter of the cover opening around the crutch to secure the cover to the crutch. Other covers are constructed from fabric configured to wrap entirely around the surface of underarm pad. In addition, some covers do not conform to the curved shaped of the underarm pads found on many crutches. Further, some covers for hand grips are constructed from a single piece of material adapted to wrap around the hand grip and include fasteners, such as a hook and loop fastener, to connect opposing ends of the hand grip covers together.

Utilizing elastic bands and/or configuring the underarm covers to wrap entirely around the surface of the underarm pad has some drawbacks. For example, connecting elastic bands to the perimeter of the opening on underarm covers results in additional manufacturing complexity and cost. Elastic bands can also make it somewhat cumbersome for people to install and remove the crutch cover. Further, repeated stretching and contraction of the elastic band can cause the band to separate from the cover and/or cause the band to permanently deform and wear out. The elastic bands on some covers also cause the cover material to wrinkle or bunch, degrading the aesthetic appearance of the cover. Still, other covers do not conform to the shape of the underarm pads, which can result in a loose fit between the cover and the pad. Additionally, using hook and loop fasteners on hand grip covers can form a significant edge protruding from the surface of the hand grip cover. In use, the engagement of such an edge with a user's hand can be a source of discomfort to the user.

### BRIEF SUMMARY OF THE INVENTION

Aspects of the present invention involve crutches that are powder coated to provide an enhanced aesthetic appearance as well as additional durability and protection to various components of the crutch. Other aspects of the present invention involve underarm covers and hand grip covers for crutches that provide additional comfort to the user while at the same time providing an improved aesthetic appearance of the crutch. The covers can be constructed from different types of fabrics with various types of designs that can be selected by the user according to his or her own preference. The underarm cover defines a curved shape that generally conforms to the curved contour of the underarm pads used on many crutch designs. Tapered end portions of a perimeter edge of an open bottom of the underarm cover defines upwardly extending slits at opposing ends of the open bottom. The underarm cover also includes opposing sides having flaps extending between the slits. The combination flaps and the slits makes it easier to remove and install the underarm cover by allowing the user to fold the sides away from each other. When the underarm cover is installed on the crutch, the flaps drape below the bottom of the underarm cover. The flaps of the underarm cover are drawn together with a coupler without wrapping or overlapping with each other around the bottom of the underarm pad. As such, wrinkling or bunching of the fabric of the underarm cover is reduced and a relatively larger area of the outer surface of the underarm cover is visible, which improves the aesthetic appearance of the crutch. The combination of the curved contour of the underarm cover with the coupler pulls the underarm cover into a relatively snug fit with the underarm pad that acts hold the underarm cover securely in place on the crutch pad. The hand grip covers are formed from a single piece of fabric sewn into a tubular shape. Because the hand grip covers are not releasably connected with a fastener, the hand grip covers provide a relatively smooth exterior the surface, which improves the comfort to the user.

In one aspect of the present invention, a crutch includes: a crutch frame having a first support member and a second support member, each having an upper end, a lower end, and an outer surface. The outer surfaces of the first and second support members are powder coated. The crutch further includes a first cross member and a second cross member, each being releasably connected with the first support member and the second support member. The first support member is connected proximate the upper ends of the first support member and the second support member. A center post is disposed between the first support member and the second support member and is releasably connected with the lower ends of the first support member and the second support member and extends therebelow. The crutch also includes a first pad adapted to receive the first cross member, wherein the first pad defines first and second rounded end portions and a concave top surface. Further, the crutch includes a crutch cover including a first fabric sheet and a second fabric sheet connected with the first fabric sheet to form a pocket. An opening of the pocket is defined by a bottom perimeter edge including at least one tapered end portion defining at least one upwardly extending slit. A top side of the pocket is correspondingly curved with the concave top surface of the first pad and is received thereby.

In another form, a crutch includes: a crutch frame having a first support member and a second support member, each having an upper end, a lower end, and an outer surface. The outer surfaces are powder coated. The crutch also includes a first cross member and a second cross member, each being releasably connected with the first support member and the second support member and having a longitudinal axis disposed substantially perpendicular thereto. The first support member is releasaby connected proximate the upper ends of the first support member and the second support member. A center post is disposed between the first support member and the second support member and affixed to the lower ends of the first support member and the second support member and extends therebelow.

In yet another form of the present invention, a crutch includes: a first support member having an first end portion and a second end portion; a second support member having an first end portion and a second end portion; a first cross member releasably connected with the first end portion of the first support member and the upper end portion of the second support member; a second cross member releasably connected with the first support member and the second support member between the first and second end portions thereof. A center support member is releasably connected with the second end portion of the first support member and the second end portion of the second support member. The first support member and the second support member are powder coated.

The features, utilities, and advantages of various embodiments of the invention will be apparent from the following more particular description of embodiments of the invention as illustrated in the accompanying drawings and defined in the appended claims.

### BRIEF DESCRIPTION OF THE DRAWINGS

FIG. 1 is a right side view of a crutch.

FIG. 2 is an isometric view of a crutch with a first embodiment of an underarm pad cover and a hand grip cover.

FIG. 3 is a right side view of a crutch with an underarm pad cover and a hand grip cover.

FIG. 4 is a cross-sectional view of the underarm pad cover and crutch depicted in FIG. 3, taken along line 4-4.

FIG. 5 is a cross-sectional view of the hand grip cover and crutch depicted in FIG. 3, taken along line 5-5.

FIG. 6A is a top left side isometric view of the underarm pad cover installed on a crutch.

FIG. 6B is a bottom left side isometric view of the underarm pad cover of FIG. 6A.

FIG. 6C is a right side elevation view of the underarm pad cover of FIG. 6A.

FIG. 6D is a front side elevation view of the underarm pad cover of FIG. 6C.

FIG. 7A is a bottom left side isometric view of the underarm pad cover in an open configuration.

FIG. 7B is a top plan view of the underarm pad cover of FIG. 7A.

FIG. 7C is a bottom plan view of the underarm pad cover of FIG. 7A.

FIG. 8A is a cross-sectional view of the underarm pad cover depicted in FIG. 7A, taken along line 8A-8A.

FIG. 8B is a cross-sectional view of the underarm pad cover depicted in FIG. 7A, taken along line 8B-8B.

FIG. 9 is an isometric view of a side of a fabric assembly.

FIG. 10 is an exploded view of a side of the fabric assembly shown in FIG. 9.

FIG. 11 is an isometric view of an assembly of right and left first fabric and padding sheets.

FIG. 12. is an isometric view of the assembled sheets shown in FIG. 11.

FIG. 13 is an isometric view of an assembly of right and left second fabric sheets.

FIG. 14 is an isometric view of the assembled sheets shown in FIG. 13.

FIG. 15 is an isometric view of an assembly of the underarm cover.

FIG. 16 is a front side view of a tassel.

FIG. 17 is a top right side isometric view of a second embodiment of the underarm pad cover installed on a crutch.

FIG. 18 is a cross-sectional view of the underarm pad cover and crutch depicted in FIG. 17, taken along line 18-18.

FIG. 19 is a bottom left side isometric view of the underarm pad cover of FIG. 17 in an open configuration.

FIG. 20 is a bottom left side isometric view of the underarm pad cover of FIG. 19 with decorative beads.

FIG. 21A is an isometric view of a fabric sheet used to construct a hand grip cover.

FIG. 21B is an isometric view of the fabric sheet of FIG. 21A stitched together to form the hand grip cover.

FIG. 21C is an isometric view of the hand grip cover.

### DETAILED DESCRIPTION OF THE INVENTION

Aspects of the present invention involve crutches that are powder coated. As described in more detail below, the powder coating process may be applied to the entire crutch frame, or a subset of the frame components. Powder coating provides an enhanced aesthetic appearance as well as additional durability and protection to various components of the crutch. Other aspects of the present invention involve covers for crutches that provide additional comfort to the user while at the same time providing an improved aesthetic appearance of the crutch. The covers include an underarm cover and a hand grip cover that can be constructed from different types of fabrics with various types of designs that can be selected by the user according to his or her own preference. The underarm cover defines a curved contour to more snugly fit an underarm pad on the crutch. Further, the underarm cover includes a coupler used to connect right and left sides that extend below the underarm pad of the crutch. The combination of the curved contour of the underarm cover with the coupler act hold the underarm cover securely in place on the crutch pad. The underarm cover also includes an open bottom with upwardly extending slits at opposing ends for ease of installation and removal. Although the underarm cover is depicted and described herein as having two upwardly extending slits, it is to be appreciated that underarm cover can be configured with one upwardly extending slit. The hand grip covers are formed from a single piece of fabric sewn into a tubular shape with a closing stitch. The closing stitch helps provide a relatively smooth exterior the surface of the hand grip cover to improve comfort for the user. While the following description of the present invention shows the crutch covers installed over pads on crutches, it is to be appreciated that the covers can be installed on crutches without pads.

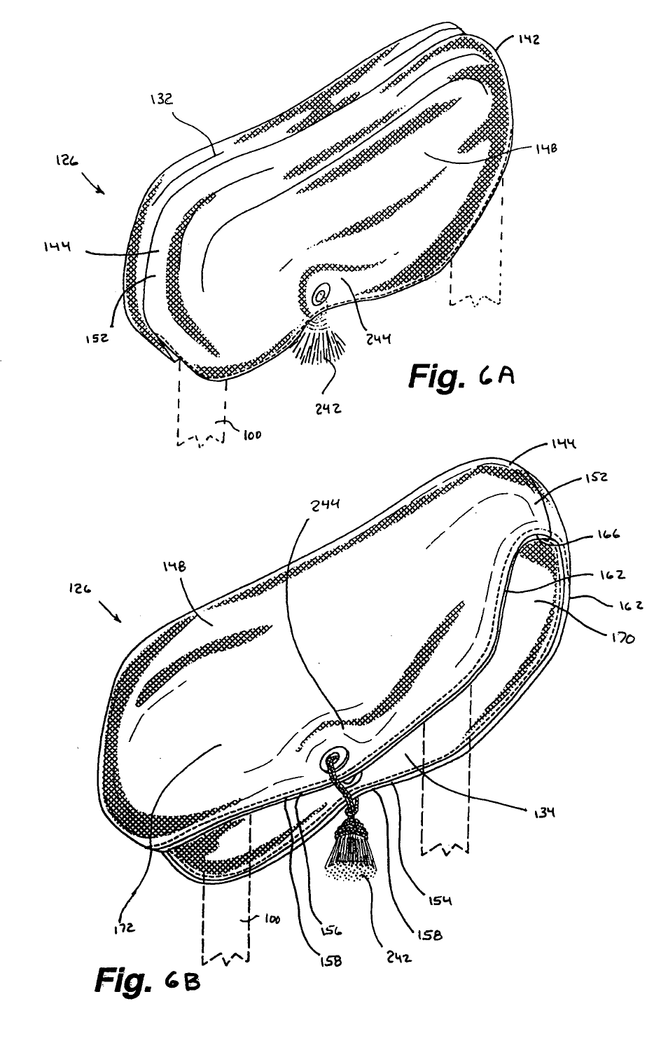

Crutches used by people to provide assistance with walking are well known in the art. As shown in FIGS. 1, 4, and 5, a crutch 100 typically includes a first cross member 102 and a second cross member 104 connected with a first support member 106 and a second support member 108. The crutch 100 depicted and described herein is for illustrative purposes only. As such, it is to be appreciated that the present invention can be used with various types of crutches configured in different ways and should not be construed to be limited to use with the crutch depicted and described herein. In use, the first cross member 102 is positioned in an underarm portion of a user's body (i.e., arm pit), and the user grasps the second cross member with his or her hand. To provide added comfort during use, the crutch can also include an underarm pad 110 adapted to connect with the first cross member 102 and a hand grip pad 112 adapted to connect with the second cross member 104.

Still referring to FIGS. 1, 4, and 5, the first cross member 102 is connected with upper end portions of the first support member 106 and the second support member 108. The cylindrically-shaped second cross member 104 is supported by a bolt 114 extending between the first support member 106 and the second support member 108. More particularly, the second cross member 108 includes a center aperture 116 adapted to receive the bolt 114, which also extends through a first aperture (not shown) in the first support member 106 and a second aperture (not shown) in the second support member 108. A nut 118 screwed onto a threaded end portion 120 of the bolt 114 helps to hold the bolt in position on the crutch. Typically, the first and second support members include a plurality of apertures along the lengths thereof to allow a user to adjust the position of the second cross member relative to the first cross member. Bottom end portions of the first and second support members taper inwardly toward each other and are connected with a center post 122. The center post is typically bolted to the first and second support members through a plurality of apertures that provide a user with the ability to adjust the overall height of the crutch. The center post can also include an end cap 124 adapted to engage a walking surface.

The underarm cover is adapted to envelope the underarm pad and the first cross member. The underarm cover is installed on the crutch by spreading right and left sides apart and sliding the underarm cover over the top the underarm pad and the first cross member on the crutch. The underarm cover includes a right fabric assembly connected with a left fabric assembly to form a pocket with a closed top side and an open bottom. Although the right and left sides have extended bottom portions, upwardly extending end slits of the open bottom define flaps in the right and left sides that allow the sides to be folded outward and spread further apart for easier installation and removal than otherwise would be possible without the end slits. Once the underarm pad cover is installed over the underarm pad, the flap of the right and left sides are releasably connected together under the first cross member with a coupler. Connecting the flaps of the right and left sides of the underarm pad cover together pulls the fabric assemblies around the underarm pad and the first cross member for a relatively snug fit. It is to be appreciated that various types of couplers can be used with the present invention, such as tassels, snaps, buttons, ties, zippers, and hook and loop fasteners. As such, the underarm covers should not be limited to utilizing the couplers depicted and described herein.

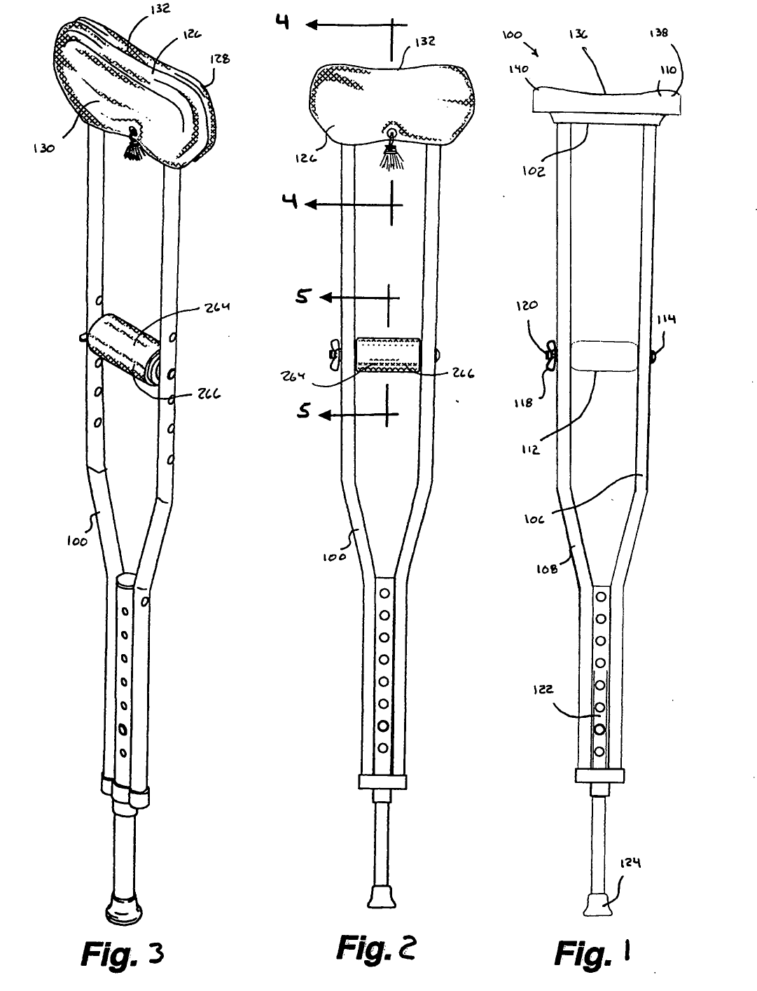

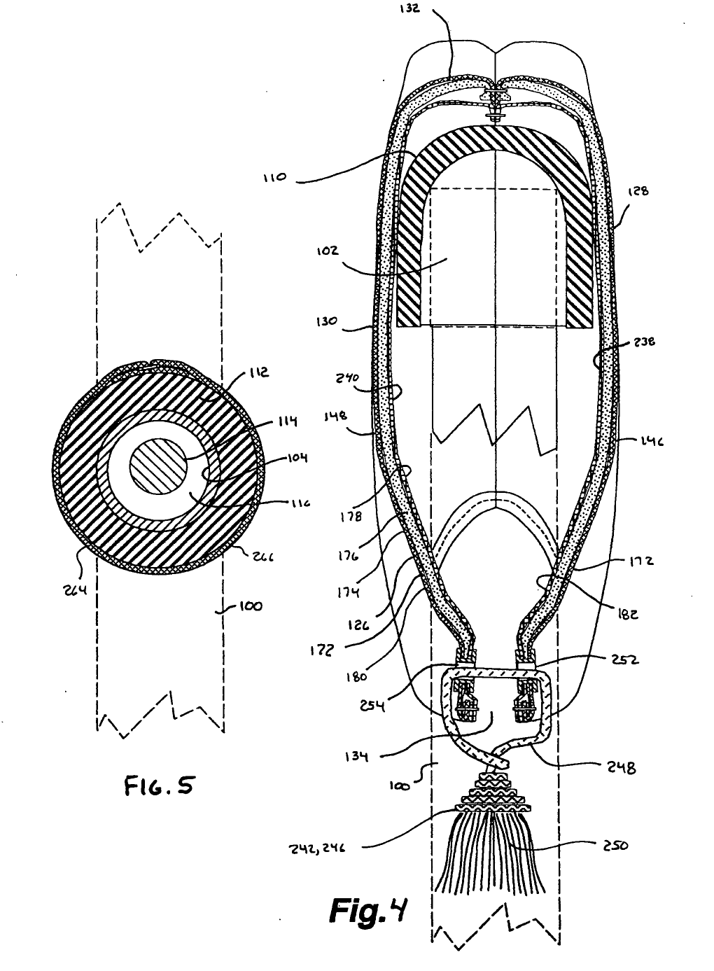

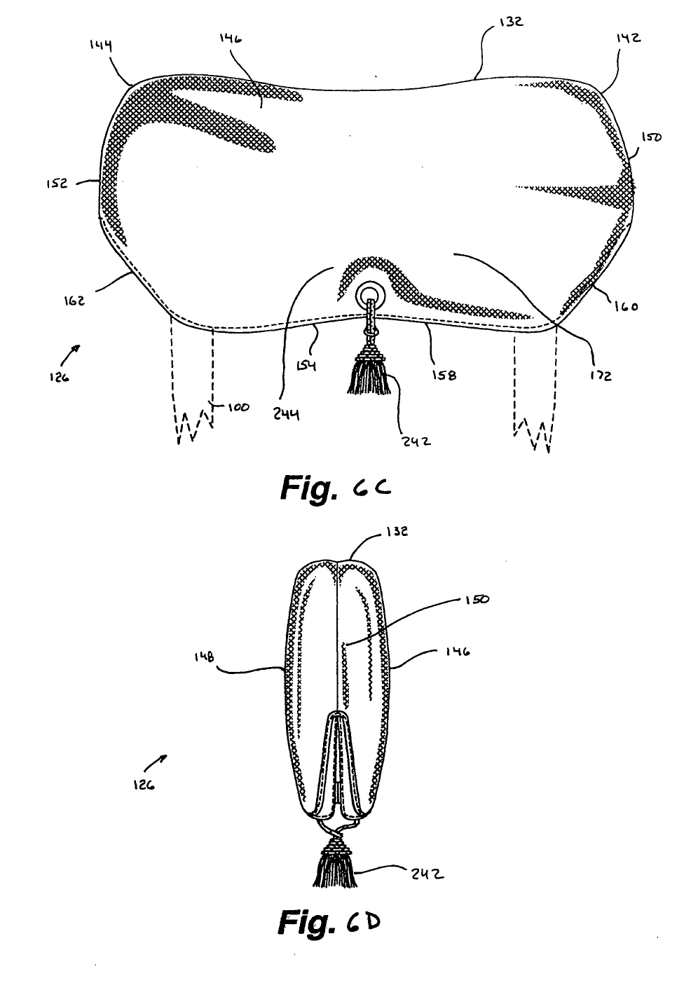

FIGS. 2-5 illustrate a first embodiment of an underarm cover 126 installed on the underarm pad of the crutch. The first embodiment of the underarm cover includes a right fabric assembly 128 connected with a left fabric assembly 130 to define a closed top side 132 and an open bottom 134. The right fabric assembly 128 is substantially a mirror image of the left fabric assembly 130. As shown in FIG. 1, the first cross member 102 and underarm crutch pad 110 on some crutches have a downwardly curving or concave top side 136 extending between rounded front and rear end portions (138, 140). As such, the underarm cover 126 is shaped to conform to shape of the first cross member 102 and underarm crutch pad 110 to provide a relatively close fit between the underarm cover 126 and the first cross member and underarm crutch pad. More particularly with reference to FIGS. 6A-6D, the top side 132 of the underarm cover extends between a front rounded corner region 142 and a rear rounded corner region 144. The connection between the top side, the right side, the left side, and front side define the generally cone-shaped front rounded corner region 142, and the connection between the top side, the right side, the left side, and rear side define the generally cone-shaped rear rounded corner region 144. The front and rear rounded corner regions (142, 144) are adapted to surround the front and rear end portions (138, 140) of the first cross member 102 and underarm crutch pad 110. Further, the top side 132 of the underarm cover 126 defines a downwardly curving or concave contour between the front and rear rounded corner regions that generally corresponds with the curvature of the first cross member 102 and underarm crutch pad 110.

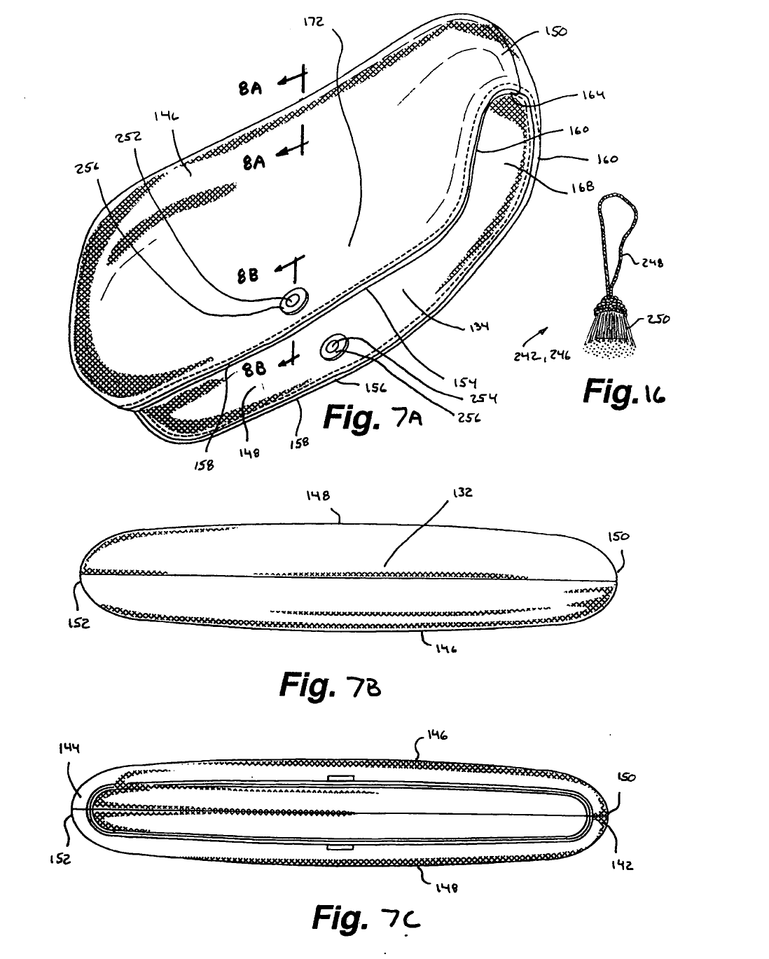

As shown in FIGS. 4, 6A-6D, and 7A-7C, the underarm cover 126 also includes right and left sides (146, 148) extending downward from the top side 132, and front and rear sides (150, 152) extending downward from the front and rear rounded corner regions (142, 144). Bottom edges of the right, left, front, and rear sides define a perimeter of the open bottom of the under arm cover. With reference to FIGS. 6B, 6C, and 7A, a right bottom edge 154 and a left bottom edge 156 of the right side 146 and left side 148, respectively, each define a relatively straight middle portion 158 extending between front and rear tapered portions (160, 162). More particularly, the front tapered portion 160 extends upward and forward from the middle portion 158 to a bottom edge 164 of the front side. The rear tapered portion 162 extends upward and rearward from the middle portion 158 to a bottom edge 166 of the rear side. The combinations of the tapered portions and the bottom edges of the front and rear sides define generally U-shaped front and rear upwardly extending slits (168, 170) in the open bottom 134. As shown in FIGS. 6A-6C, flaps 172 of the right and left sides are defined by areas between the front and rear slits of the open bottom. The front and rear slits (168, 170) of the open bottom 134 allow the flaps 172 of the right and left sides to be spread relatively far apart when installing the underarm cover on the crutch. This reduces the likelihood of the sides of the underarm cover from being caught or hung-up on the sides of the underarm pad when installing or removing the underarm cover. As such, the front and rear slits of the underarm cover provide for easier installation and removal of the underarm cover.

As shown in FIGS. 4 and 9-10, the right and left fabric assemblies (126, 128) each include a first fabric sheet 174 and a second fabric sheet 176 connected together on opposing sides of a padding sheet 178 or batting sheet. As discussed in more detail below and shown in FIG. 4, outer sides of the first fabric sheets 174 form an outer covering 180 of the underarm cover 126, and inner sides of the second fabric sheets 178 form an interior lining 182 of the underarm cover 126. The padding sheet 176 provides added cushion to the underarm cover for increased comfort to the user. Although the padding sheet is slightly smaller than the first and second fabric sheets, the first and second fabric sheets and the padding sheet are similarly shaped. As such, each of the first and second fabric sheets and the padding sheet define a flat bottom edge 184. The bottom edge 184 of each sheet includes a forward tapered edge 186 connecting with a front edge 188 and a rearward tapered edge 190 connecting with a rear edge 192. From the forward and rearward tapered edges (186, 190), the forward and rearward edges (188, 192) extend upward to an arcuately-shaped forward corner edge 194 and an arcuately-shaped rearward corner edge 196, respectively. A top edge 198 extends from the rearward corner edge 196 to the forward corner edge 194. The top edge 198 is also concave, curving downward toward the bottom edge 184 between the forward and rearward corner edges (194, 196). It is to be appreciated that the actual dimensions of the first and second fabric sheets (174, 178) can vary depending upon the size of the underarm crutch pad 110 and/or first cross member 102 of the crutch 100. For example, in one embodiment of the present invention, the distance between the bottom edge and the top edge of the first and second fabric sheets is 5 inches. This enables the flaps of the right and left sides to connect with each other when the underarm cover is installed on the crutch without requiring the underarm cover to completely wrap around the bottom of the first cross member.

It is to be appreciated that the first and second fabric sheets (174, 178) can be made from various types of fabrics with various different designs that can be selected by the user. For example, in some embodiments of the present invention, the first fabric sheet is made from polar fleece, silk, or 100% silk brocade. Still, in other embodiments, the second fabric sheet is made from denim or twill. In addition, the padding or batting sheet 176 can have different thicknesses and can also be made from various types of material. For example, some embodiments of the present invention utilize batting made from ¼ inch thick polyester, while other embodiments utilize ½ inch thick batting. In addition to selecting a particular design to enhance the aesthetic appearance of the underarm cover and hand grip cover, the crutch can be painted or powder coated with a particular color to better coordinate with the selected design for the covers.

The process of powder coating the crutch, in addition to affording an enhanced aesthetic appearance, also provides additional durability and protection for the various frame components of the crutch, including first cross member 102, second cross member 104, first support member 106, second support member 108, and center post 122. The powder coating process additionally provides further impact strength, weatherability, corrosion resistance, and color steadfastness for the frame components. Because first cross member 102 and second cross member 104 may be shielded by an underarm cover and a hand grip respectively, as described herein, the powder coating may alternatively be applied only to first support member 106, second support member 108, and center post 122. The frame components may be constructed of aluminum or another material with an advantageous strength-to-weight ratio.

Systems and methods for electrostatically applying powder coatings are known in the art and are described in U.S. Pat. No. 3,904,346, U.S. Pat. No. 4,380,320, and U.S. Pat. No. 5,567,468, which are hereby incorporated by reference. In one embodiment, a spray gun (not shown) arranged with a spray gun nozzle is directed towards the crutch frame components to be coated. The various frame components, which may be movably adjustable with respect to each other, are preferably disassembled prior to spraying so as to avoid adhesion of these components. Electrically charged powder particles are combined with a stream of air and are emitted from the spray gun. The powder coating particles may be finely ground particles of any of a number of resins, such as a vinyl, acrylic, epoxy, phenolic or urethane resin, or the coating particles may be a mixture of finely ground pigment and resin particles. The powder coating may have any of a number of colors determined by the pigment to coordinate with the underarm cover and hand grip cover of the crutch.

A resultant high-voltage, low amperage electric static charge is emitted as the powered particles are discharged from the gun nozzle towards the frame components. The frame components are grounded so that they are neutrally charged. Accordingly, the frame components attract the powder particles, and the particles adhere to the surface of the frame components. The frame components are sprayed in a controlled manner that yields a uniform level of coating on the component surfaces. Additionally, the spray is controlled to avoid affecting the diameter of the various apertures in the frame components.

The frame components are then transferred to a large curing oven, where the temperature is raised to melt and flow the particles together and cure them to the components. In one embodiment, the temperature in the oven is raised to approximately 400° Fahrenheit for approximately one half hour. The frame components are then removed from the oven and are allowed to cool to room temperature. The resultant coating is a uniform 2-5 mils adhered to the frame components. The components are then assembled into a crutch as shown in FIG. 1.

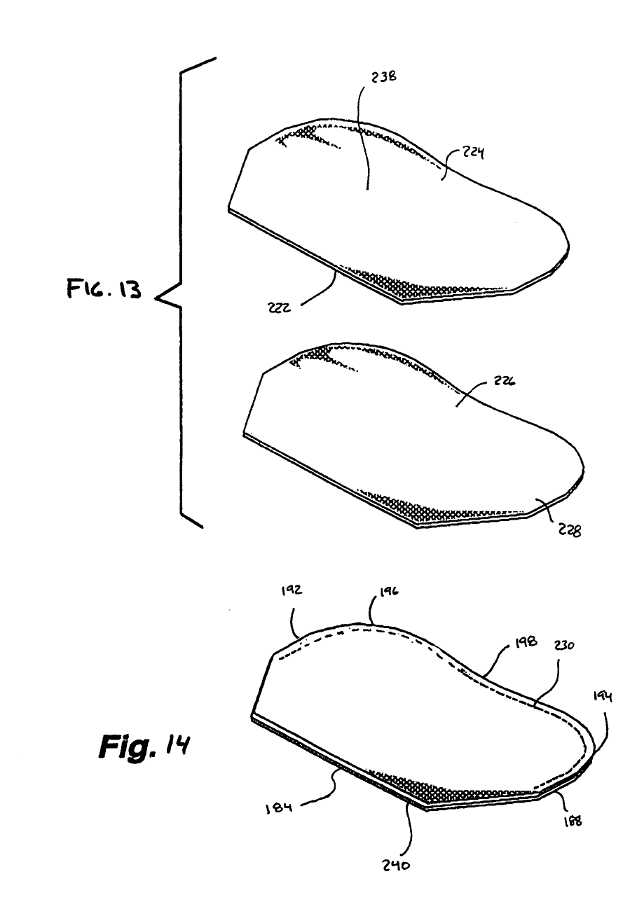

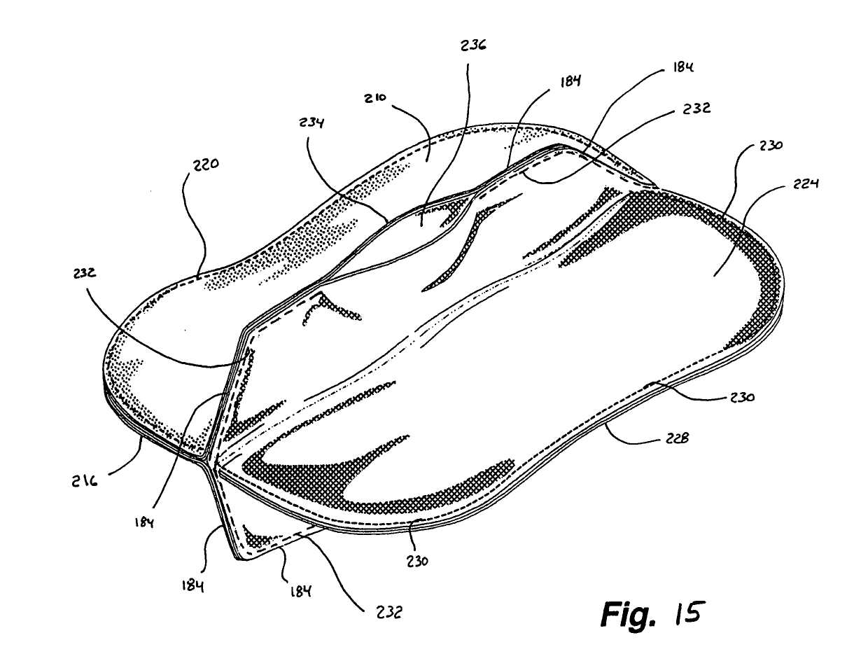

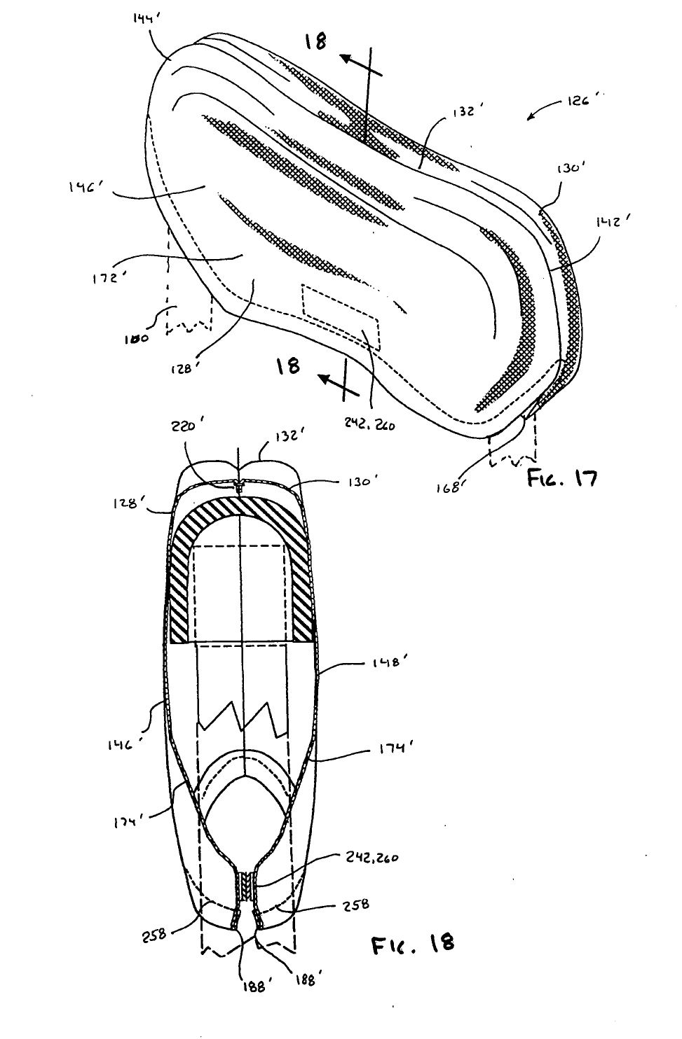

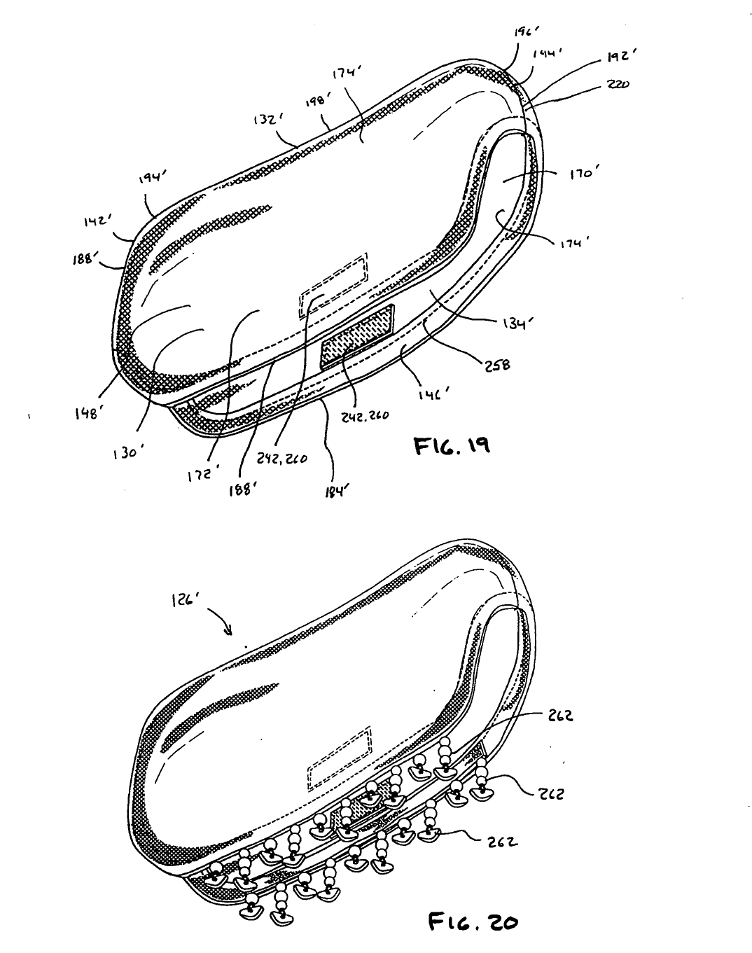

FIGS. 9-15 show the assembly of the first and second fabric sheets (174, 178) and the batting sheet (176) to form the right and left fabric assemblies (128, 130) shown in FIG. 4 and the underarm cover (126). As shown in FIG. 11, when assembling the underarm cover 126, an outer side 200 of a right first fabric sheet 202 is first placed adjacent to an outer side 204 of a left first fabric sheet 206. Next, an outer side 208 of a right padding sheet 210 is placed adjacent to an inner side 212 of the right first fabric sheet 202, and an outer side 214 of a left padding sheet 216 is placed adjacent to an inner side 218 of the left first fabric sheet 206. As shown in FIG. 12, the sheets are then connected together with a first stitch 220 extending along the rear edges 192, the rearward corner edges 196, the top edges 198, forward corner edges 194, and the front edges 188. Next, as shown in FIG. 13, an inner side 222 of a right second fabric sheet 224 is placed adjacent to an inner side 226 of a left second fabric sheet 228. The right and left second fabric sheets are then connected together with a second stitch 230 extending along the rear edges 192, the rearward corner edges 196, the top edges 198, forward corner edges 194, and the front edges 188, as shown in FIG. 14.

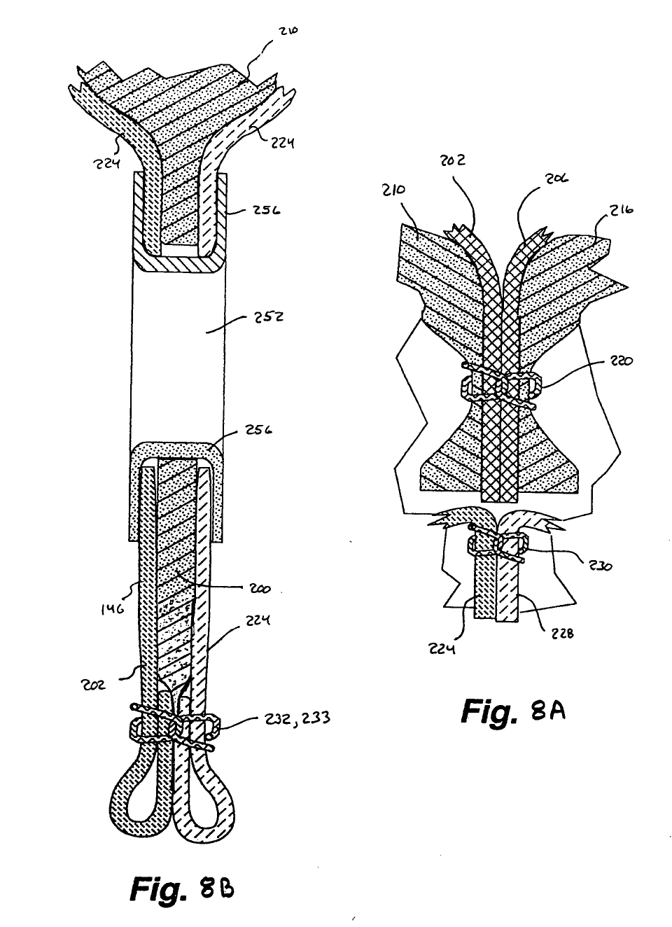

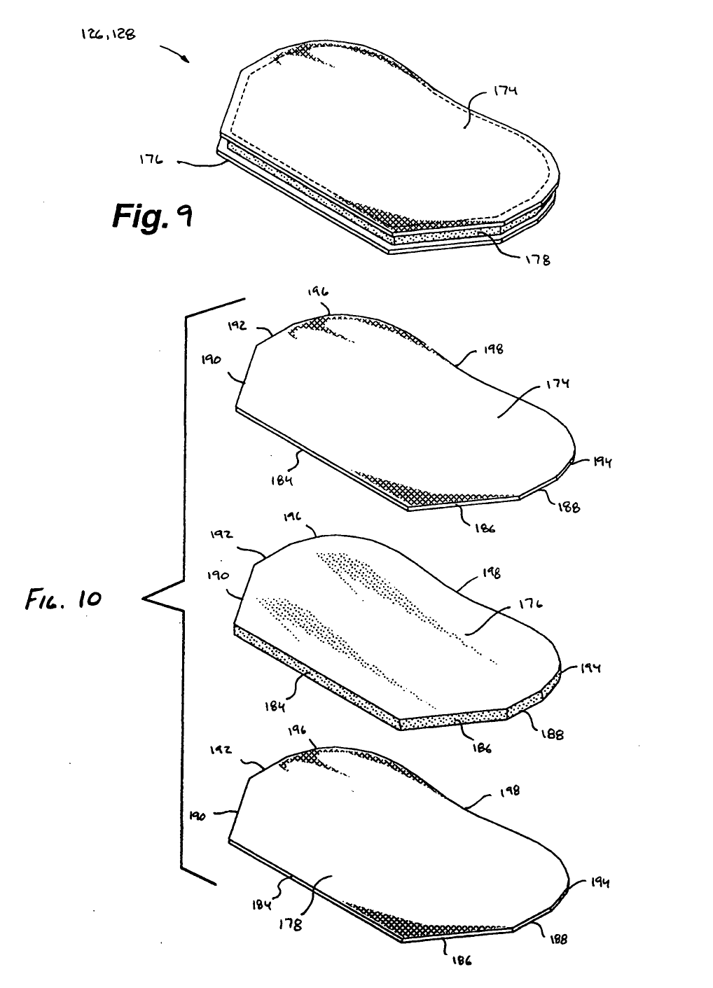

As shown in FIG. 15, the bottom edges 184 of the connected first fabric sheets and batting sheets of FIG. 12 are positioned along the bottom edges 184 of the connected second fabric sheets of FIG. 14. A third stitch 232 spaced inward from the bottom edges 184 is then used to connect the sheets together. As shown in FIG. 15, the third stitch 232 is placed along the entire perimeter of the bottom edges 184 except for a relatively short length 234, leaving a gap or an opening 236 between the sheets. The connected sheets are then folded inside out through the gap 236. A fourth stitch 233 is then extended along the length of the third stitch 232 and the relatively short length 234, which closes the gap 236. As such, inner sides (238, 240) of the second fabric sheets (224, 228) are placed in a face-to-face relationship, forming the interior lining 182 of the underarm cover as shown in FIG. 4. FIG. 8A shows a detailed cross-sectional view of the first and second stitches (220, 230) of the assembled underarm cover 126, and FIG. 8B shows a detailed cross-sectional view of the third and fourth stitches (232, 233) of the assembled underarm cover.

Referring to FIGS. 6B, 6C, 7A, 9, and 10, the shape of the arcuately-shaped upper forward and rearward corner edges (194, 196) of connected sheets form the front and rear rounded corner regions (142, 144) of the underarm cover 176. In addition, the concave or curved top edges 198 of the connected sheets form the curved contour of the concave or curved top side 132 of the underarm cover 126. Further, the forward and rearward tapered edges (186, 190) of the connected sheets form the front and rear slits (168, 170) of the open bottom 134 of the underarm cover 126. As previously mentioned, the front and rear slits of the open bottom provide for relatively easier installation and removal of the underarm cover even though the right and left sides (146, 148) include extended bottom portions. The combination of the front and rear corner regions and curved top side of the underarm cover generally correspond with the shape of the first cross member 102 and the underarm pad 110 of the crutch 100. The corresponding shapes act to provide a relatively close fit between the underarm cover and the first cross member and underarm crutch pad.

As shown in FIGS. 4, 6A-6B, and 7A, once the underarm cover 126 is placed on the crutch 100, a coupler 242 is used to help secure the underarm cover 126 on the crutch 100 by connecting the right and left sides (146, 148) together under the first cross member 102. The coupler also acts to pull the fabric assemblies (128, 130) tighter around the underarm pad 110 and the first cross member 102, resulting in a tighter fit between the underarm cover and pad. When the underarm cover is installed on the crutch, the flaps 172 of the right and left sides (146, 148) extend below the first cross member of the crutch. The flaps of the right and left sides are connected together with the coupler 242 located between the slits (168, 170) of the open bottom 134. More particularly, the coupler 242 holds regions 244 of the flaps 172 in contact with each other or in close proximity with each other underneath the first cross member 102 of the crutch 100. Pulling the regions 244 of the flaps 172 of the right and left sides (146, 148) toward each other under the first cross member pulls the fabric assemblies tighter around the underarm pad and the first cross member. More particularly, the curved top side 132 of the underarm cover 126 is pulled downward against the top side 136 of the underarm pad 110. The right and left sides (146, 148) are also pulled to curve inward toward each other, partially wrapping around corresponding sides of the underarm pad 110 and first cross member 102. Further, connecting the flaps 172 of the right and left sides (146, 148) together tends to pull the front and rear rounded corner regions (142, 144) against corresponding front and rear end portions (138, 140) shown in FIG. 1 of the underarm pad 110 and first cross member 102. In some embodiments, tension in the fabric pulls bottom edges (164, 166) shown in FIG. 7A of the front and rear sides (150, 152) under the front and rear end portions (138, 140) of the first cross member 102.

As previously mentioned, various types of couplers 242 can be used with the underarm cover 126. As best shown in FIGS. 4 and 16, the coupler 242 utilized in the first embodiment of the underarm cover is a tassel 246, which includes a thread loop 248 connected with a tassel head 250. The tassel 246 is connected with the right and left sides (146, 148) by first passing the thread loop 248 through right and left apertures (252, 254) located in the flaps 172 of the right and left sides (146, 148). Once the thread loop 248 is passed through the right and left apertures, the tassel head 250 is then passed through the loop 248. In use, the weight of the tassel head pulls on the thread loop, which in turn, pulls the flaps of the right and left sides closer together. To protect the material surrounding the right and left apertures from damage from the threaded loop, grommets 256 can be installed around the apertures (252, 254), as shown in FIG. 7A. FIG. 8B shows a detailed cross sectional view of the grommet 256 installed in the right side 146 of the underarm cover. Depending upon the type of grommet used, interfacing or reinforcing fabric can be placed around the grommet to help secure the grommet to the material of the cover.

A second embodiment of the underarm cover 126′ is shown in FIGS. 17-19. The second embodiment, like the first embodiment, provides a curved or concave top side, rounded corner regions, and extended right and left sides. Structurally, the second embodiment varies from the first in several ways. For example, the right and left fabric assemblies of the second embodiment are constructed from first fabric sheets and do not include second sheets or padding sheets. Further, the second embodiment utilizes a hook and loop fastener as the coupler, as opposed to the tassel used on the first embodiment.

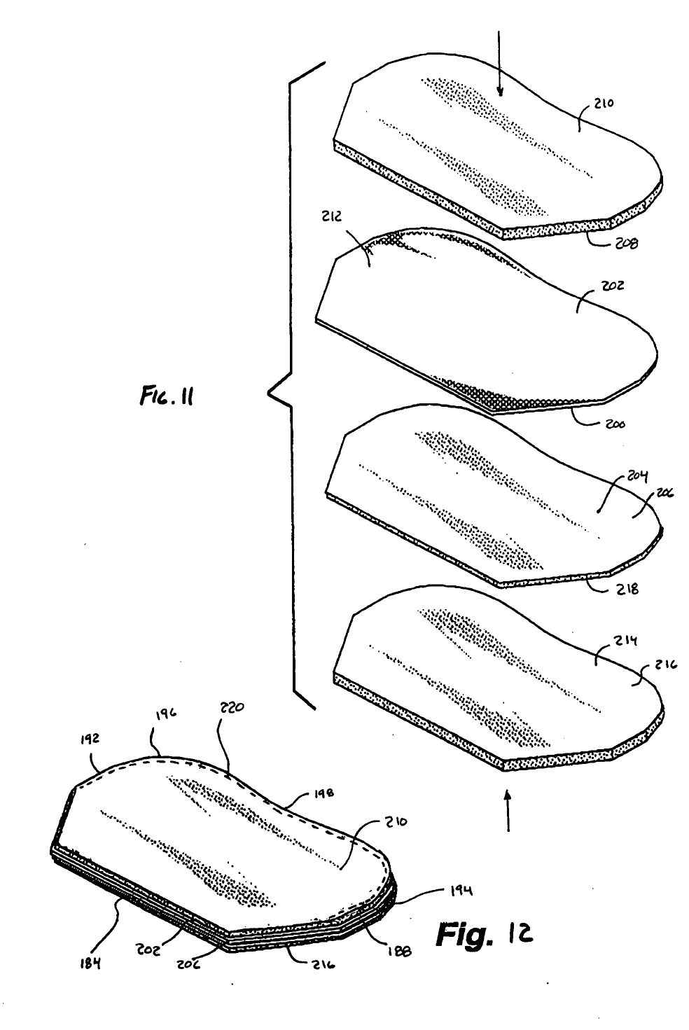

As shown in FIGS. 17-19, the underarm cover includes a right fabric assembly 128′ connected with a left fabric assembly 130′. The underarm cover defines a concave or curved top side 132′ and rounded corner regions (142′, 144′) adapted to surround the first cross member 102 and underarm crutch pad 110. The open bottom 134′ of the underarm cover also defines slits (168′, 170′) to allow for easier installation and removal. The coupler 242 on the flaps of the right and left sides (146′, 148′) provide a releasable connection between the right and left sides under the first cross member. The right and left fabric assemblies (128′, 130′) are constructed from first fabric sheets 174′ similar to those depicted in FIGS. 9 and 10. As shown in FIGS. 18 and 19, the first fabric sheets are connected with a first stitch 220′ extending along the rear edges 192′, the rearward corner edges 196′, the top edges 198′, forward corner edges 194′, and the front edges 188′ of the first fabric sheets 174′. As shown in FIG. 19, the bottom edges 184′ of the fabric sheets can also be folded inward on themselves and held in place with a bottom stitch 258 extending along right and left bottom edges.

As previously mentioned and as shown in FIG. 19, the second embodiment of the underarm cover 126′ utilizes a hook and loop fastener 260 connected with the flaps 172′ of the right and left sides (146′, 148′) as the coupler. It is to be appreciated that various types of hook and loop fasteners can be used with the present invention, such as Velcro®. As shown in FIGS. 17 and 18, the hook and loop fastener 260 connects the right and left sides (146′, 148′) together under the first cross member 102 of the crutch. As discussed above with reference to the first embodiment, the coupler on the second embodiment also acts to pull the fabric assemblies onto and around the surface of the underarm pad and the first cross member. As shown in FIG. 20, a plurality of decorative beads 262 can also be connected around the bottom edge of the underarm cover 126′. In some embodiments, the beads act as noise makers as the user walks with a crutch. The noise makers alert others in close proximity to the user to help reduce the likelihood of an accidental collision.

FIGS. 2, 3, and 5 illustrate one embodiment of a hand grip cover 264 installed on the hand grip pad 112 of the crutch 100, which defines a fabric tube 266 adapted to receive the hand grip pad 112. The hand grip cover 264 is installed by first removing the hand grip pad 112 and the second cross member 104 from between the first and second support members (106, 108). For the crutch shown in FIG. 1, removal of the second cross member would require the removal of the nut 118 and bolt 114. Once the second cross member 104 and hand grip pad 112 are removed, the hand grip cover 264 is slid over the outer surface of the hand grip pad. The second cross member and hand grip pad along with the hand grip cover are then reinstalled by first placing the second cross member in the desired position between the first and second support members. Once the second cross member is in position, the bolt 114 is inserted through the first and second support members and the second cross member and the nut 118 is screwed onto the threaded end portion 120 of the bolt.

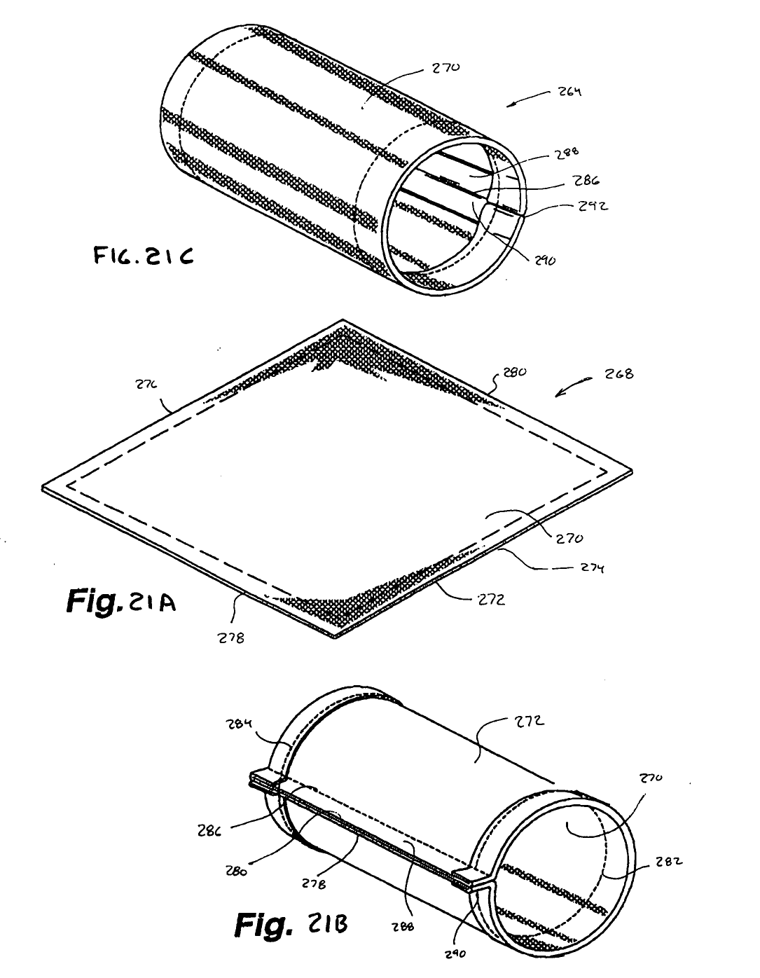

FIGS. 21A-21C illustrate the assembly of the hand grip cover. As shown in FIG. 21A, a generally rectangularly-shaped sheet of fabric 268 having a first side 270 and a second side 272 is used to construct the hand grip cover. The sheet of fabric 268 also defines first 274, second 276, third 278, and fourth edges 280. When assembling the hand grip cover 264, the first and second edges are folded over onto the second side 272 and held in place with a first edge stitch 282 and a second edge stitch 284, respectively, shown in FIG. 21B. Next, the third and fourth edges (278, 280) are placed adjacent to each other such that the sheet of fabric forms a tube with the second side 272 forming the outer surface. A closing stitch 286 spaced inward from the third and fourth edges is then used to connect the sheet of fabric in the tubular shape. The placement of the closing stitch inward from the third and fourth edges forms first and second extensions (288, 290). The hand grip cover 264 is then folded inside out such that the first side 270 defines the outer surface of the tube. The first and second extensions are folded adjacent to the inner surface of the tube. As such, a seam 292 created by the closing stitch 286 and the extensions creates a relatively flat surface, providing additional comfort to the user.

It will be appreciated from the above noted description of various arrangements and embodiments of the present invention that covers for an underarm pad and first cross member of a crutch as well as a hand grip cover have been described. The underarm cover can be formed in various ways and utilize various types of couplers depending upon type of and size of crutch upon which it is installed. It will be appreciated that the features described in connection with each arrangement and embodiment of the invention are interchangeable to some degree so that many variations beyond those specifically described are possible. For example, the underarm cover can be assembled with a partial or full lining and with or without padding. In addition, the stitches described herein can utilize various types of threads. For example, some embodiments utilize polyester thread, while others use threads made from a poly/cotton blend.

Although various representative embodiments of this invention have been described above with a certain degree of particularity, those skilled in the art could make numerous alterations to the disclosed embodiments without departing from the spirit or scope of the inventive subject matter set forth in the specification and claims. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A crutch comprising:
a crutch frame comprising a first support member and a second support member, each having an upper end, a lower end, and an outer surface, wherein said outer surfaces are powder coated, a first cross member and a second cross member, each being connected with said first support member and said second support member, said first cross member being connected proximate said upper ends of said first support member and said second support member, and a center post disposed between said first support member and said second support member and releasably connected with said lower ends of said first support member and said second support member and extending therebelow;
a first pad adapted to receive said first cross member, wherein said first pad defines first and second rounded end portions and a concave top surface; and
a crutch cover comprising
a first fabric sheet; and
a second fabric sheet connected with said first fabric sheet to form a pocket, wherein an opening of said pocket is defined by a bottom perimeter edge including at least one tapered end portion defining at least one upwardly extending slit, and wherein a top side of said pocket is correspondingly curved with said concave top surface of said first pad and is received thereby.

2. The crutch of claim 1, wherein said center post is powder coated.

3. The crutch of claim 2, wherein said first cross member and said second cross member are powder coated.

4. The crutch of claim 1, wherein said first support member and said second support member are powder coated with a melted powder with a thickness of 2-5 mils.

5. The crutch of claim 1 further comprising:
a second pad defining a hollow cylindrical shape adapted to receive said second cross member; and
a sheet of fabric defining a tube adapted to receive said second pad.

6. The crutch of claim 1, whereby said at least one upwardly extending slit defines a first flap and a second flap allowing portions of said first fabric sheet and said second fabric sheet to be folded apart from each other during installation and removal of the cover on the crutch.

7. The crutch cover of claim 1, wherein said at least one upwardly extending slit comprises a first upwardly extending slit and a second upwardly extending slit; and
wherein said first fabric sheet includes a first flap extending between said first upwardly extending slit and said second upwardly extending slit, and said second fabric sheet includes a second flap extending between said first upwardly extending slit and said second upwardly extending slit.

8. A crutch comprising:
a crutch frame including a first support member and a second support member, each having an upper end, a lower end, and an outer surface, wherein said outer surfaces are powder coated, a first cross member and a second cross member, each being connected with said first support member and said second support member and having a longitudinal axis disposed substantially perpendicular thereto, said first cross member being connected proximate said upper ends of said first support member and said second support member, and a center post disposed between said first support member and said second support member and affixed to said lower ends of said first support member and said second support member and extending therebelow.

9. The crutch of claim 8, wherein said center post is powder coated.

10. The crutch of claim 9, wherein said first cross member and said second cross member are powder coated.

11. The crutch of claim 10, wherein said first cross member defines first and second rounded end portions and a concave top surface.

12. The crutch of claim 11, further comprising:
a crutch cover for said first cross member, said crutch cover comprising a first fabric sheet and a second fabric sheet connected with said first fabric sheet to form a pocket; and
wherein an opening of said pocket is defined by a bottom perimeter edge including at least one tapered end portion defining at least one upwardly extending slit.

13. The crutch of claim 12, wherein a top side of said pocket is correspondingly curved with said concave top surface of said first cross member.

14. The crutch of claim 8, wherein said first support member and said second support member are powder coated with a melted powder with a thickness of 2-5 mils.

15. A crutch comprising:
a first support member having an first end portion and a second end portion;
a second support member having a first end portion and a second end portion;
a first cross member connected with said first end portion of said first support member and said first end portion of said second support member;
a second cross member releasably connected with said first support member and said second support member between said first and second end portions thereof;
a center support member releasably connected with said second end portion of said first support member and said second end portion of said second support member; and
wherein said first support member and said second support member are powder coated.

16. The crutch of claim 15, wherein said center post is powder coated.

17. The crutch of claim 15, wherein said first cross member and said second cross member are powder coated.

18. The crutch of claim 15, wherein said first cross member defines first and second rounded end portions and a concave top surface.

19. The crutch of claim 18, further comprising:
a cover for said first cross member, said cover defining a pocket having a top side; and
wherein said top side of said pocket is correspondingly curved with said concave top surface of said first cross member.

20. The crutch of claim 19, wherein said cover further comprises:
a first fabric sheet and a second fabric sheet connected with said first fabric sheet to form a pocket; and
wherein an opening of said pocket is defined by a bottom perimeter edge including at least one tapered end portion defining at least one upwardly extending slit.
